(19) United States
(12) Patent Application Publication
(10) Pub. No.: US 2002/0108094 A1
(43) Pub. Date: Aug. 8, 2002

(54) System and method for designing integrated circuits

(76) Inventor: Michael Scurry, San Jose, CA (US)

Correspondence Address: FLEHR HOHBACH TEST, ALBRITTON & HERBERT LLP, Suite 3400, Four Embarcadero Center, San Francisco, CA, 94111-4187, US

(21) Appl. No.: 09/778,182

(22) Filed: Feb. 6, 2001

(51) Int. Cl. G06F 17/50

(52) U.S. Cl. 716/5

(57) ABSTRACT

A system (100) and method are provided for developing customized integrated circuits (ICs) for use in an external system (105) while connected to the external system. In one embodiment, the system (100) includes a development board (115) for holding an IC core (120), the board having several ports (125) for transmitting signals to and from the IC core. A computer (130) with hardware descriptor language (HDL) software running thereon, coupled to the development board to configure the IC core to form the IC. Interface software (180), also running on the computer (130), translates Register Transfer Level (RTL) code entered by a designer to code used by the HDL software, (180) includes program code for enabling the designer to (i) assign predetermined signals in the RTL code to predetermined ports (125); (ii) assign a clock speed for the IC core (120); determine if the IC core can operate at the assigned clock speed; (iii) designate the ports to be monitored; and (iv) designate an output to be recorded in a VCD file.

### INTRODUCTION

1. Technical Field

The present invention relates generally to systems for developing integrated circuits, and more particularly to an In-System-Developer and method for quickly and efficiently designing and testing the design of customized integrated circuits for use in an external system while connected to the external system.

2. Background

In recent years, advances in semiconductor manufacturing technology, in which an ever growing number of components are integrated into a single semiconductor substrate, have made possible the manufacture of customized and semi-customized integrated circuits (ICs) designed with the aid of computers from known elements, thereby enabling their price, performance and reliability of the ICs to be optimized and their design time to be reduced.

These ICs include, for example, Application-Specific Integrated Circuits (ASICs) and Field Programmable Gate Arrays (FPGAs). ASICs are ICs designed to perform a particular function by defining the interconnection of a set of basic circuit building blocks drawn from a library provided by the circuit manufacturer. An ASIC typically performs a specific digital function. FPGAs are high density Programmable Logic Devices (PLDs) that can be programmed by the user to perform a variety of logical operations. FPGAs typically contain small logic cells interconnected through a distributed array of programmable switches. Programmability typically is accomplished via either volatile Static Random Access Memory (SRAM) or one-time-programmable anti-fuses. A flowchart illustrating the sequence of steps and time consumed in designing an IC according to a conventional process is shown in FIG. 1. Conventional techniques for designing and manufacturing or fabricating ICs can take from about 1 to about 1½ years from conception to completion of the final product. The majority of this time is spent in developing a hardware architecture from a written specification, coding, that is developing code, for the IC, and verification of the design prior to fabrication of a working prototype.

Generally, there are two different types of coding, those using a Hardware Descriptor Language or HDL and those using another non-HDL program language or program. Two industry standard HDL codes include, for example, VHSIC Hardware descriptive Language (VHSIC is an acronym for Very High Speed Integrated Circuits) or VHDL and IEEE Standard 1364 or VERILOG. Either VHDL or VERILOG can be used to code a particular digital design that is synthesis ready. By synthesis ready it is meant the ability to convert code into gates, by mapping the code to a technology library using a synthesis tool. One coding style widely used to provide a synthesis ready design is Register Transfer Logic or RTL. If the design is not synthesisable we call this style behavioral, this is much like an implementation of the design using program coding. An example of an industry standard program language for program coding using a non-HDL coding or programming is C language. As noted above, C language can be used to describe the behavioral function of a digital design. Prior art methods and apparatuses for designing and testing ICs, such as emulators discussed below, can typically accept structural level RTL only if the method and apparatus are FPGA based. Otherwise, processor based, conventional emulators will accept C code or HDL code.

Referring to FIG. 1, it is seen that developing the hardware architecture (step 10) can take from 2 to 4 weeks, coding (step 15) can take from 1 to 2 months, verification (step 20) about 6 months, and fabrication of a working prototype (step 25) about 8 months. Moreover, the conventional approach or technique is generally an iterative process in which a working prototype is repeatedly subjected to verification testing, and, if the custom IC should fail to yield the desired performance, the coding for the IC must typically be revised and the verification of the design repeated prior to fabrication of a second working prototype. Thus, the time required for coding (step 15) and verification (step 20) can have a significant impact on the time and cost for designing and manufacturing or fabricating ICs.

One conventional technique for verifying an IC design uses software simulation. In this technique, software in a general-purpose computer portrays the circuit and the computer performs all the steps necessary to simulate operation of the circuit. This technique is time consuming in that a user or designer must program the computer both for each of the circuit elements and to simulate all signals internal to the simulated circuit. Moreover, the above simulation technique is severely limited by the operating speed of the computer used to simulate the design. For example, a high performance computer can currently clock the simulated design at a maximum rate of approximately 500 MHz. As a result, simulating the response of an IC design to a single second of data can take from 3 to 5 days and full verification of the design using simulation could take months or even years. Furthermore, if a problem is discovered during the verification testing of the design, additional weeks or months must be spent fixing, typically involving re-coding, and re-simulating to verify the design. Thus, software simulation is an expensive and time-consuming process.

An alternative to simulation is to perform verification testing using a custom prototype. The engineer constructs a custom prototype using programmable logic and a dedicated target board. The custom prototype approach provides the most realistic circuit of all conventional techniques and can simulate the desired circuit the faster than simulation since the custom prototype employs dedicated processors and interface components. However, this approach is also very expensive requiring a custom target board for each device and time-consuming since it means starting from scratch for each design. Moreover, if a modification is desired (e.g., due to an error or design change), modifying the custom prototype can be expensive and time-consuming.

Yet another approach involves emulating the IC using a processor or an FPGA. Emulation systems are described in, for example, U.S. Pat. No. 5,109,353, to Sample et al. and U.S. Pat. No. 5,036,473, to Butts et al. Examples of processor based emulators include Philips 8051 family, commercially available from U.S. Philips Corporation, of New York, N.Y., and Cobalt, commercially available from QuickTurn, a division of Cadence Co., of San Jose, Calif. The Philips 8051 is a reconfigurable micro-controller. In this type of emulation the designer loads assembly or C code that mimics a certain design. The emulator usually has a computer interface, for loading the compiled code. It may also contain external inputs and outputs (I/Os) for connecting to the external circuit or system for which the emulated part is intended. While an improvement over simulation, this type of emulation has a major drawback. That is the testing of the IC design is limited by the cycle time of the micro-controller. Thus, performance of the IC being emulated is reduced due to cycle time of a processor of the micro-controller, RAM access time, bus time, and etcetera. Therefore, the effective speed at which the IC can be tested or verified using emulation is typically much slower than processor speed, and may in fact be much slower than the speed at which the IC must ultimately function in the external circuit. As a result, verification time is increased and the thoroughness with which the IC can be tested is decreased. In an extreme case it may not be possible to emulate and test the IC under anticipated actual operating conditions and speeds, leading to need for re-coding, re-verification and fabrication of multiple prototypes.

An example of the second type of emulator, an FPGA based emulator, is MercuryPlus also available from QuickTurn. This emulator typically includes multiple custom FPGAs arranged on one or more boards. These boards are then connected to a backplane system. The connection to the backplane, facilitates I/O and interconnect communication between design blocks and the intended external circuit or system for which the design is intended. One problem with this type of emulator is cost, with average prices starting in at $500,000. This high cost arises from the fact that the emulator typically comes equipped with partitioning, probing and synthesis software, and typically has capabilities that are unnecessary for testing custom and semi-custom ICs, which usually relative low gate-count, i.e., less than about 50,000 gates. Yet another, related, problem with this type of emulator is that it has a very low portability, owing to both the size and number of the subsystems and the interconnections between the subsystems. This makes it difficult to move the emulator from one facility to another, or even within the same facility in order to maximize it use, thereby amortizing its' cost. Thus, such an emulator is generally not economically practical for designing and testing custom and semi-custom ICs having a low gate-count.

Another problem with conventional techniques for designing ICs involves generating a test bench to develop a proper self-checking test for all ports on the manufactured IC. This is particularly a problem with conventional design techniques in which initial test vectors often cannot fully test the IC, and it is often necessary after the first ICs are fabricated to modify the test vectors or develop new test vectors. This in turn leads to longer times for designing and manufacturing ICs.

### SUMMARY

Accordingly, there is a need for an apparatus and method that reduces the time necessary to develop the hardware architecture and coding, and verify the design of ICs. It is desirable that the apparatus and method provide rigorous verification of the IC design to reduce or eliminate the need for multiple prototypes. It is further desirable that the apparatus and method provide test vectors for test bench generation, and be compatible with industry standard tools for simulation, static timing analysis and test vector generation. The present invention provides these and other advantages over the prior art.

In one aspect, the present invention is directed to an In-System-Developer (ISD) for developing an IC for use in an external system while connected to the external system. In one embodiment, the ISD includes a development board for holding an IC core, the development board having a number of ports for transmitting signals to and from the IC core. A data processing system is coupled to the development board by at least one cable or via other data transmitting means. Hardware Descriptor Language (HDL) software running on the data processing system configures reconfigurable elements in the IC core to form the circuit of the IC. Interface software, also running on the data processing system, is adapted to translate Register Transfer Level (RTL) code entered by a user or designer to code used by the HDL software, thereby enabling the design to be tested as it is being developed. Generally, the interface software further includes program code adapted to allow the designer to assign first predetermined signals to first predetermined ports on the development board. The interface software includes program code adapted to enable the designer to designate the ports on the development board to be monitored, and to designate an output from a port or ports to be recorded in a Value Change Dump (VCD) file.

In one version of this embodiment, the designer is using a Universal Test & Operations Physical Interface for ATM (UTOPIA), and the interface soft ware is adapted to translate UTOPIA RTL code.

In another embodiment, the interface software includes program code adapted to enable the designer to assign a clock speed for the IC core. Desirably, the interface software includes program code adapted to determine if the IC core is capable of operating at the assigned clock speed.

The apparatus and method of the present invention is particularly useful for developing customized ASICs and/or high density PLDs such as FPGAs. In one embodiment, the ISD typically includes an interface using a computer program product, described in detail below.

In another aspect, a method or process is provided for quickly and efficiently developing an IC. In the method, an IC core is provided and mounted in a development board having a number of ports for transmitting signals to and from the IC core. The development board is coupled to a data processing system, such as a general-purpose computer, and HDL software executed to configure the IC core to form a desired circuit for the IC. RTL code entered by a designer is translated to code used by the HDL software using interface software, thereby enabling the designer to test the design as it is being developed. Generally, the method includes the further step of assigning predetermined signals in the RTL code to predetermined ports on the development board using the interface software.

In one embodiment, the designer uses a UTOPIA interface and the step of translating RTL code involves translating UTOPIA RTL code.

In another embodiment, the method includes the further step of assigning a clock speed at which the IC core is tested using the interface software. Desirably, this is preceded by the step of determining prior to assigning a clock speed if the IC core is capable of operating at the assigned clock speed.

In yet another embodiment, the method includes the further steps of designating from which ports signals are to be recorded into a VCD file, and generating a test bench using data in the VCD file to enable self-checking of the IC core. Generally, the interface software includes program code adapted both to enable the designer to designate ports on the development board to be monitored, and to designate ports to be recorded in a VCD file or during test bench creation.

In yet another aspect, the invention is directed to a computer program product for developing an IC for use in an external system while connected to the system. The computer program product includes a computer readable storage medium having computer program embedded therein. The computer program, includes a program module that directs the data processing system coupled to the development board having an IC core held therein, to function in a specified manner, to translate RTL code entered by the designer to code used by the HDL software to configure the IC core to form the IC, thereby enabling the designer to test a design as it is being developed. Generally, the program module includes program code for enabling the designer to (i) assign predetermined signals in the RTL code to predetermined ports; (ii) assign a clock speed for the IC core; determine if the IC core can operate at the assigned clock speed; (iii) designate the ports to be monitored; and (iv) designate an output from a port or ports to be recorded in a VCD file.

The present invention increases the speed and efficiency with which ICs are designed and tested by using an FPGA, thereby removing the limitation of processor speed of the processor in an external data processing system. The advantages of the apparatus and method of the present invention include: (i) reducing the verification testing cycle in IC design, (ii) enabling hardware testing of a development design while code is being written, (iii) ability to work with a wide range of IC cores from various manufacturers and (iv) ability to test design of the ICs at different clock speeds prior to fabrication of a prototype.

### BRIEF DESCRIPTION OF THE DRAWINGS

These and various other features and advantages of the present invention will be apparent upon reading of the following detailed description in conjunction with the accompanying drawings, where:

FIG. 1 (Prior Art) is a flowchart illustrating the sequence of steps and time consumed in designing an IC according to a conventional process;

FIG. 2 is a diagram of a system for designing an IC according to an embodiment of the present invention;

FIG. 3 is a functional block diagram of a development board for developing an IC according to an embodiment of the present invention;

FIG. 4 is a flowchart illustrating the sequence of steps in a process for developing a hardware interface for designing an IC according to an embodiment of the present invention; and

FIG. 5 is a flowchart illustrating the sequence of steps in a process for designing an IC according to an embodiment of the present invention.

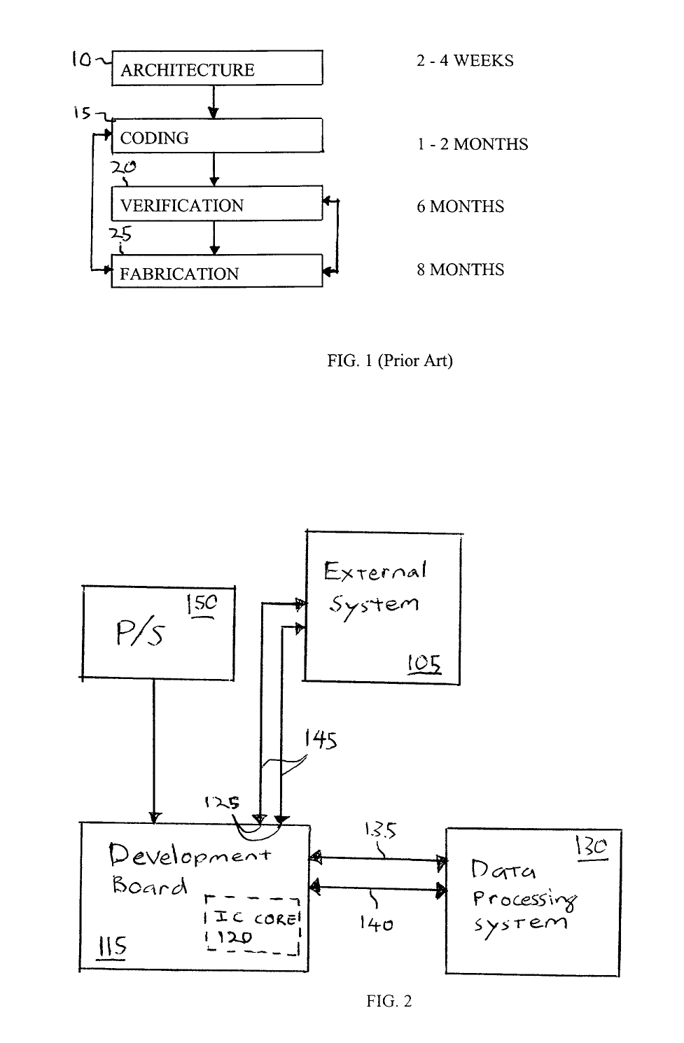

### DETAILED DESCRIPTION

The present invention is directed to a system and method for quickly and efficiently designing and testing the design of an IC using an IC core.

By IC core it is meant a particular intellectual property (IP) used within an IC. For example, several IC cores or IPs are used in a System-on-Chip approach of semiconductor design. Suitable IC cores include, for example, low gate count ASIC, FPGA or ERGA, such as a Utopia2 and a 10/100 MAC, both commercially available from Experience First, Inc., of San Jose, Calif. Each IC core comes with a library of devices supplied by the manufacturer that enables a user or designer to build or form the hardware architecture of the IC by specifying connections between the available devices.

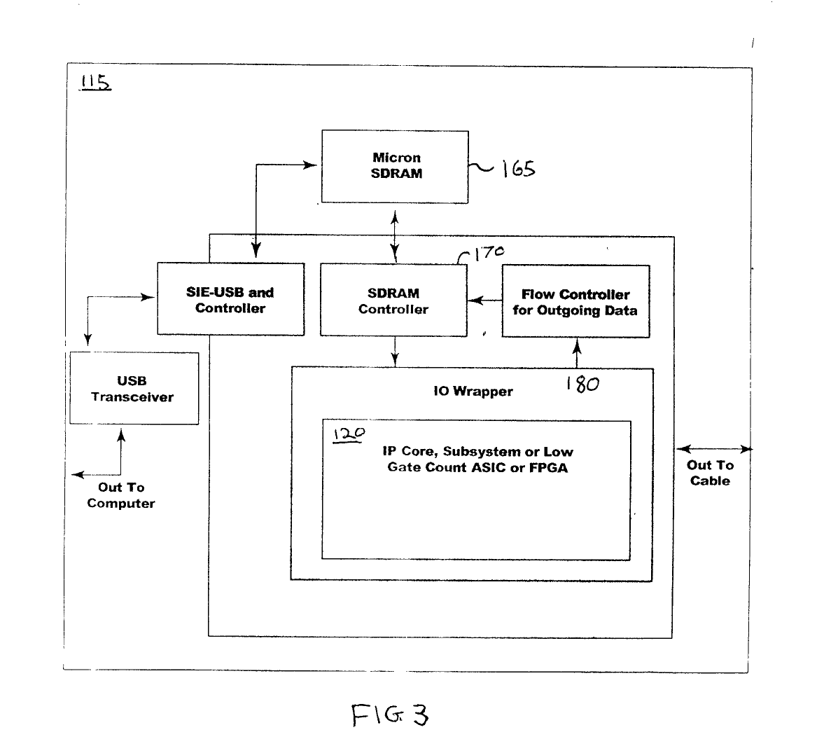

FIG. 2 illustrates an exemplary embodiment of an In-System-Developer (ISD) 100 for developing an IC for use in an external system 105 while connected to the external system. The ISD 100 generally includes a development system 110 having a development board 115 for holding an IC core 120 (shown in phantom), the development board including a number of ports 125, including input and output ports, for transmitting data and signals to and from the IC core, a computer or data processing system 130 coupled to the development board by a number connections 135, 140, and an input-output (I/O) cable 145 or other data transmitting means coupling the ports to the external system 105 for transmitting data from the external system 105 to the IC core and transmitting signals from the IC core to the external system 105. Hardware descriptor language (HDL) software (not shown) executed by the data processing system 130 configures the IC core to form or create the hardware architecture of the IC. A wrapper or interface software (not shown), also executed by the data processing system 130, configures the IC core and serves as an interface between the IC core and Register Transfer Level (RTL) code entered by a user or designer, translating the RTL code to code used by the HDL software, thereby enabling the designer to test the design as it is being developed.

A power supply 150 supplies power (for example, from about 3.0 to about 5.0 volts DC) to supply power to the IC core, the development board 115 and any transceivers (not shown in this figure) necessary to enable the development board to communicate with the data processing system 130 or the external system 105.

A functional block diagram of a development board 115 for developing an IC according to an embodiment of the present invention is shown in FIG. 3. Referring to FIG. 3, the development board 115 generally has one or more sockets (not shown) for accepting the IC core 120, switches (not shown) to configure or select circuit connections to pins of the sockets, and from about 16 Kilobytes to about 1 Gigabytes of RAM 165 and a memory controller 170 for controlling data flow to and from the data processing system. Typically, each of the sockets has from about 100 to about 20,000 pins arranged in various configurations to accommodate IC cores 120 of various designs. In addition, there is at least one oscillator or system clock 175 that is adapted to enable the designer to adjust the rate at which the IC core 120 is clocked from about 40 MHz to about 2 GHz. The development board 115 can be any suitable development board, such as a Virtex™ Board commercially available from Avnet Inc., of Phoenix, Ariz. The Virtex™ development board includes a universal serial bus (USB) connector and a parallel connector for connecting to the data processing system via a USB cable and a parallel data cable, and a number of I/O connectors such as a 64-bit PCI interface connector and a general-purpose I/O interface, which are used in the present invention for connecting to the external system 105.

By HDL it is meant any one of several source languages that describes circuits in textual code in a technology-independent manner using a high level of abstraction. In one embodiment, the ISD 100 and the method of the present invention are compatible with one or more commonly available HDL software, for example, the two most widely accepted HDL software programs, VHDL and Verilog. One suitable HDL software is Xilinx Foundation Series software commercially available from Xilinx Inc., of San Jose, Calif. This HDL software is particularly suited for use with the Virtex development board described above.

For example, in one embodiment, the designer uses an asynchronous transfer mode (ATM) interface, such as a UTOPIA interface, to communicate between the data processing system 130 and the actual cards, wires, and/or fiber-optic cabling used to connect to the IC core 120. In accordance with the present invention, the interface software 180 includes program code adapted to translate RTL code entered by a designer to code used by the HDL software, thereby enabling the designer to test the design as it is being developed to be tested. For example, when the designer is using a UTOPIA interface, the interface software 180 is adapted to translate UTOPIA RTL code entered by a designer, thereby enabling the designer to test the design as it is being developed. In particular, the interface software 180 enables the connections to each of the ports 125 from the external system 105 to be specified, to determine which outputs from the IC core 120 to monitor and/or record, and to assign a clock speed for the IC core. A significant advantage of the present invention is that all this is accomplished while receiving live data from the external system 105. In contrast, a designer using a conventional system with merely a conventional ATM interface, such as UTOPIA and having only a preliminary code, may determine the IC passes all tests in a simulation. By preliminary code it is meant a first draft, alpha or beta version of the code for the design being developed. However, as noted above, simulation is generally not sufficient where serial communication is concerned since simulation cannot mimic actual conditions properly without actually interfacing with the external system 105. In contrast, using an ISD 100 and the method according to the present invention has a distinct advantage in that it has the ability to use the preliminary UTOPIA RTL code to connect to an ATM system, thereby enabling waveforms of signal outputs to be captured and the effects of changes to the code to be seen immediately. This enables the user to develop and debug a design in hardware while still working on the RTL code.

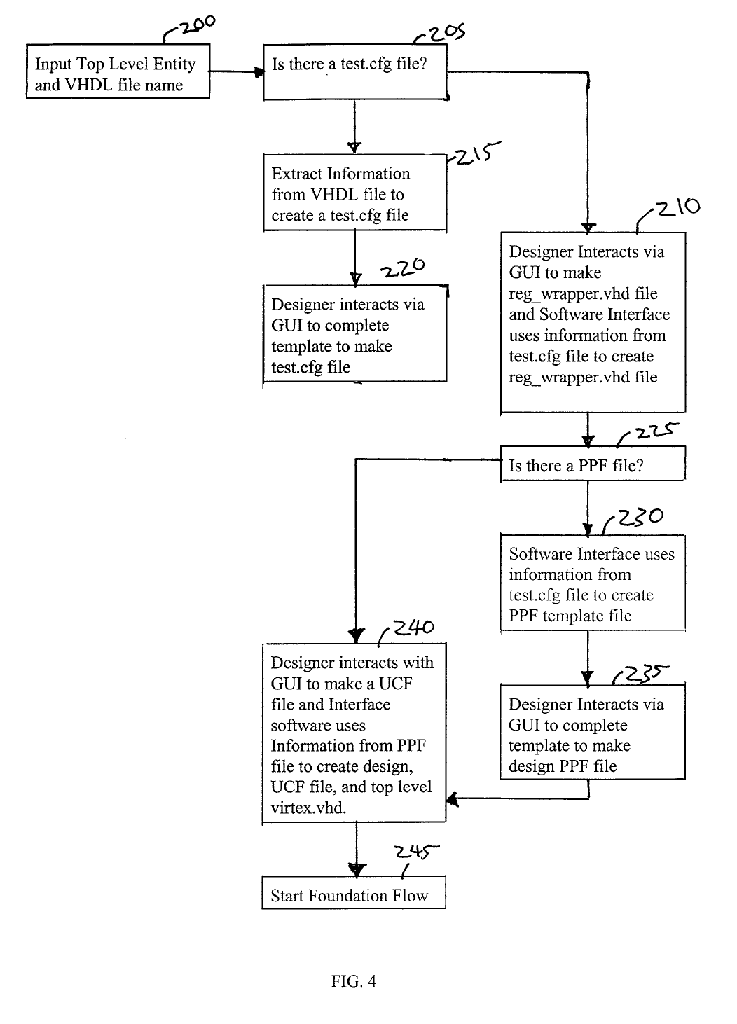

A method or process for developing the interface hardware will now be described with reference to FIG. 4. FIG. 4 is a flowchart illustrating the sequence of steps in a process for developing the hardware interface for designing an IC according to an embodiment of the present invention. In a first step, a top level entity and an HDL language file name are entered (Step 200). The data processing system 130 then determines if a test configuration file already exists using the top level entity and the HDL language file name (Step 205). If the test configuration file, shown here as test.cfg, does exist, the designer interacts via a Graphical User interface (GUI) with the HDL language file and the test configuration file to generate a reg_wrapper.vhd file (Step 210). The reg_wrapper.vhd file will enable the interface software to interface between the IC core and the RTL code of the hardware interface. If no test configuration file exists, information is extracted from the HDL language file and the designer interacts via a GUI to create a template test configuration file (step 215). The reg_wrapper.vhd file for the interface software is generated as above in step 210. The designer then alters the template test configuration file to his needs (step 220). That is, in the test configuration file, the designer defines which signals are to be observed, which signals are static, clock and which signals interface with the outside elements, such as the external system 105, through I/O connectors.

Once a proper test configuration file is created, the interface software according to the present invention is used to build the hardware architecture (RTL code) to support the test configuration. In one embodiment, this file is called a reg_wrapper.vhd, and includes all information relating to data encode, control buffering of data communications, and any other information relating to support architecture needed to observe the various input and output signals. Generally, the test configuration file further includes program code to instantiate or represent a concrete instance of the hardware of the design that is being developed. The data processing system 130 then determines if a Pad Placement File or PPF file already exists (step 225). In another embodiment, when the interface software creates the test configuration file it also creates a Pad Placement File or PPF template file (step 230). This PPF file contains all of the I/Os that interact with elements, circuits and systems outside the physical hardware of the ISD 100, such as the external system 105. The designer then interacts via a GUI to alters and complete this template for particular requirements of physical elements attached to ISD 100 (step 235). For example, if a signal A has to be attached to a first pad, D27 on the IC core 120 and signal B to a second pad, A27, this information would be put in the PPF file. After this file is complete the designer then interacts via a GUI with the interface software to create an I/O constraint file, such as a Xilinx UCF file (step 240), which is used by the Foundation tools or HDL software, such as Xilinx Foundation Series software to proceed through the Foundation Flow (step 245). At the same time the UCF file is being generated, a top level RTL file, virtex.vhd, is also created. This file contains all of the I/O information and also calls the reg_wrapper design. It also contains the supporting data communication architecture (SIE engine, device controller, etc.) for USB support. When the designer is at this stage he is ready for the Xilinx Foundation flow. The Foundation Flow generates a bit file that is downloaded into ISD 100 via the parallel I/O cable 145. Optionally, the development board 115 further includes an indicator, such as a light (not shown), that indicates when the download is complete, and the development board is ready to be connected to the external system 105 or a simulator (not shown) for testing.

The ISD 100 of the present invention can greatly reduce the testing cycle for ICs including ASICs and FPGAs. The ISD 100 and method of the present invention enables the designer to know if the simulation modeling is correct for a given external system 105, and aid in finding any un-simulated flaws in the design. Furthermore, the ISD 100 and method of the present invention enables the designer to know if the design will work in the external system 105 with live data and at the intended speed prior to producing a prototype. This is in contrast to prior art systems and methods in which the IC may not work as intended in the external system with live data or be able to run at intended speed.

In another aspect, the ISD 100 and method of the present invention provide the ability to create more robust test structures by generating a test bench for testing an actively operating IC prior to and after insertion within the external system 105. The test bench generation is a byproduct of information already gathered in the design process to make a proper VCD file. To make a proper self-checking test some or all of the dynamic input and output ports should be observed on the IC core 120. The interface software of the present invention changes data from the ports 125 to create a new test-bench file for the HDL simulation software. The ports are observed in time slices (this is the sampling rate). This information is captured in word form (word in this case is 16 bits or 8 bytes). This word form is already encoded based on the I/O architecture (by the interface software). This encoded information is then stored in the resident ram on the board. The size of the resident ram controls the size of the sample size. After storage of the sample it is streamed from the board to the host computer via USB cable. Since the host computer and the interface software created the architecture for the data transmitting, the decoding of the incoming data is already known. From this decoded data a VCD and a self-checking testbench created. Decode is just a matter of aligning each time slice to its appropriate I/O arrangement. For example, bit one in the time slice is assigned to signal A and bit two is assigned to signal B and so on. Once the sample is decoded there is a snap shot of all I/O activity for that sample time frame. Since the interface software knows what to expect from the input verses the output of the synchronous design it can now create a self-checking testbench. Furthermore, a VCD file is created for waveform viewing.

Once the test-bench has been created it can be used on any desired simulator of the designer's choosing to provide an actual test from the actual system environment in which the IC will be operating. Thus, the efficiency of both the design and the development processes are greatly enhanced by the present invention.

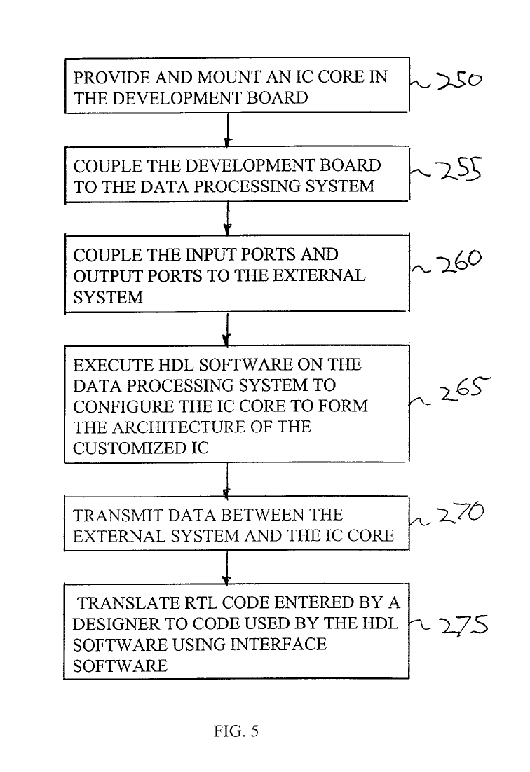

Methods or processes for operating the ISD 100 to design an IC according to an embodiment of the present invention will now be described with reference to FIG. 5. Referring to FIG. 5, in the method, an IC core is provided and mounted in a development board 115, step 250, having a number of ports 125. The development board 115 is coupled via ports 125 to the data processing system 130, step 255, and to the external system (Step 260). HDL software is executed on the data processing system 130 to configure the IC core 120 to form the architecture of the IC (Step 265). Data is transmitted between the external system 105 and the IC core 120, step 270, and RTL code entered by a designer is translated to code used by the HDL software using interface software (Step 275).

It is to be understood that even though numerous characteristics and advantages of certain embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed.

What is claimed is:

1. An In-System-Developer (ISD) for developing a customized integrated circuit (IC) for use in an external system while connected to the external system, the ISD comprising:
a development board for holding an IC core, the development board having a one or more ports for transmitting data and signals to and from the IC core;
a data processing system coupled to the development board;
hardware descriptor language (HDL) software capable of being executed by the data processing system to configure the IC core to form the IC;
at least one input-output (IO) cable coupling the ports to the external system for transmitting data from the external system to the IC core and transmitting signals from the IC core to the external system; and
interface software having program code adapted to translate Register Transfer Level (RTL) code to code used by the HDL software, thereby enabling the design to be tested as it is being developed.

2. An ISD according to claim 1, wherein the interface software further comprises program code adapted to assign predetermined signal in the RTL code to predetermined ports on the development board.

3. An ISD according to claim 1, wherein is using a Universal Test & Operations Physical Interface for ATM (UTOPIA) interface and wherein the interface software is adapted to translate UTOPIA RTL code.

4. An ISD according to claim 1, wherein the interface software comprises program code adapted to enable assigning a clock speed for the IC core.

5. An ISD according to claim 4, wherein the interface software comprises program code adapted to determine if the IC core is capable of operating at the assigned clock speed.

6. An ISD according to claim 1, wherein the interface software comprises program code adapted to enable designating ports on the development board to be monitored.

7. An ISD according to claim 6, wherein the interface software comprises program code adapted to enable designating an output to be recorded in a VCD file.

8. An ISD according to claim 1, wherein the IC core is selected from a group consisting of:
Field Programmable Gate Arrays; and
Electronically Reconfigurable Gate Arrays.

9. A method for developing a integrated circuit (IC) for use in an external system while connected to the system, the method comprising steps of:
mounting an IC core in a development board having a one or more ports for transmitting signals to and from the IC core;
coupling the development board to a data processing system;
coupling the one or more ports to the external system;
executing on the data processing system hardware descriptor language (HDL) software to configure the IC core to form the IC;
transmitting data between the external system and the IC core; and
translating Register Transfer Level (RTL) code to code used by the HDL software using interface software, whereby a design of the IC is tested as it is being developed.

10. A method according to claim 9, further comprising the step of assigning predetermined signals in the RTL code to predetermined ports on the development board using the interface software.

11. A method according to claim 9, using a Universal Test & Operations Physical Interface for ATM (UTOPIA) interface and wherein the step of translating RTL code comprising the step of translating UTOPIA RTL code.

12. A method according to claim 9, further comprising the step of assigning a clock speed at which the IC core is tested using the interface software.

13. A method according to claim 12, further comprising the step of prior to assigning a clock speed determining if the IC core is capable of operating at the assigned clock speed.

14. A method according to claim 9, further comprising the step of designating from which ports signal are to be recorded in a VCD file.

15. A method according to claim 9, further comprising the step of generating a test bench using data in the VCD file to enable self-checking of the IC core.

16. A computer program product for developing a integrated circuit (IC) for use in an external system while connected to the system, the computer program product comprising a computer readable storage medium and a computer program mechanism embedded therein, the computer program mechanism, comprising:
a program module that directs a data processing system coupled to a development board having an IC core held therein, to function in a specified manner, to translate Register Transfer Level (RTL) code to code used by hardware descriptor language (HDL) software to configure the IC core to form the IC, thereby enabling the design to be tested as it is being developed.

17. A computer program product according to claim 16, wherein the program module includes program code for assigning predetermined signals in the RTL code to predetermined ports on the development board.

18. A computer program product according to claim 16, using a Universal Test & Operations Physical Interface for ATM (UTOPIA) interface and wherein the program module includes program code for translating UTOPIA RTL code.

19. A computer program product according to claim 16, wherein the program module includes program code for assigning a clock speed for the IC core.

20. A computer program product according to claim 19, wherein the program module includes program code for determining if the IC core is capable of operating at the assigning clock speed.

21. A computer program product according to claim 15, wherein the program module includes program code for designating the ports on the development board to be monitored.

22. A computer program product according to claim 21, wherein the program module includes program code for designating an output to be recorded in a VCD file.
